(19) United States
(12) Patent Application Publication
(10) Pub. No.: US 2019/0251852 A1
(43) Pub. Date: Aug. 15, 2019

(54) Decision Aid Method And System For A Landing On A Landing Runway

(71) Applicant: Airbus Operations S.A.S., Toulouse (FR)

(72) Inventor: Fabien Moll, Toulouse (FR)

(73) Assignee: Airbus Operations S.A.S., Toulouse (FR)

(21) Appl. No.: 16/261,708

(22) Filed: Jan. 30, 2019

(30) Foreign Application Priority Data
Feb. 15, 2018 (FR) 18 51288

(51) Int. Cl. G08G 5/02

(52) U.S. Cl. CPC G08G 5/025

(57) ABSTRACT

A decision aid system includes an acquiring module for acquiring at least one current flight parameter of the aircraft, a reception module for receiving a set of information comprising runway characteristic data concerning at least the landing runway on which the aircraft is likely to land, an estimation module for estimating at least one likelihood of at least one state in which the aircraft can be upon the landing, an estimation module for estimating at least one probability of transition between the state or states estimated by the estimation module, an assessment computation module for in-flight assessment of at least one landing distance likely to be travelled by the aircraft on the landing runway, a determination module for determining at least one landing recommendation, a sending module for sending a signal representative of the landing recommendation or recommendations to a user device.

### FIELD OF THE INVENTION

The present invention relates to a decision aid system, prior to a start of final descent of an aircraft, for a landing on a first landing runway.

### BACKGROUND OF THE INVENTION

The absence of in-flight assessment of landing performance of an aircraft is one of the factors contributing to the risk of the aircraft departing from the runway in a landing.

To avoid the risk of runway departure, the pilot of the aircraft must generally take account of available information in order to be able to calculate the landing distance before the final descent of the aircraft for the landing. This information can consist of information on the environment, information on the status of the aircraft or of a combination of such information associated with the experience of the pilot and with a landing strategy. The landing strategy comprises a strategy based on the cost of the landing, the time or a safety margin before a runway end. During the final descent, the pilot must check that the landing conditions are not degraded in order to ensure that the calculation of the landing distance is still acceptable for a landing without runway departure. Otherwise, the pilot must recalculate the landing distance or decide on a diversion or a go-around. Through this procedure, the pilot is required to take account of a large quantity of information. Furthermore, the pilot is not always capable of identifying all the possible landing options.

### BRIEF SUMMARY OF THE INVENTION

Aspects of the present invention may overcome these drawbacks by proposing a decision aid method and system, prior to a start of final descent of an aircraft for a landing on a first landing runway. The method and the system make it possible to offer the pilot several possible landing options.

The invention relates to a decision aid method prior to a start of final descent of an aircraft for a landing on a first landing runway.

According to an aspect of the invention, the decision aid method comprises the following steps:

an acquisition step, implemented by an acquiring module, consisting in acquiring at least one current flight parameter of the aircraft;

a first reception step, implemented by a first reception module, consisting in receiving a first set of information comprising runway characteristic data concerning at least the first landing runway on which the aircraft is likely to land;

a first estimation step, implemented by a first estimation module, consisting in estimating at least one likelihood of at least one state in which the aircraft can be upon the landing, at least from the current flight parameters and the runway characteristic data;

a second estimation step, implemented by a second estimation module, consisting in estimating at least one probability of transition between the state or states estimated in the first estimation step;

an assessment computation step, implemented by an assessment computation module, consisting in computing an in-flight assessment of at least one landing distance likely to be travelled by the aircraft on at least the first landing runway from the likelihood or likelihoods of the state or states and from the transition probability or probabilities;

a determination step, implemented by a determination module, consisting in determining at least one landing recommendation from the landing distance or distances;

a sending step, implemented by a sending module, consisting in sending a signal representative of the landing recommendation or recommendations to a user device.

Thus, by virtue of the invention, it is possible to offer the pilot several landing strategies which take account of several parameters and information concerning the aircraft and the landing runway. The workload of the pilot is then lightened; which allows the pilot to focus on the landing.

Furthermore, the first set of information received in the first reception step also comprises at least runway characteristic data concerning at least one second landing runway on which the aircraft is likely to land if the landing recommendation determined in the determination step recommends not landing on the first landing runway.

Advantageously, the decision aid method also comprises an uncertainty computation step, implemented by an uncertainty computation module, consisting in computing, respectively, an uncertainty:

for each of the current flight parameter or parameters, and

for each of the runway characteristic data concerning at least the first landing runway,

each uncertainty being computed from an accuracy model associated:

with each of the current flight parameter or parameters, and

with each of the runway characteristic data concerning at least the first landing runway.

Moreover, the uncertainty computation step consists also in respectively computing an uncertainty:

for each of the runway characteristic data concerning at least the second landing runway,

each uncertainty being computed from an accuracy module associated:

with each of the runway characteristic data concerning at least the second landing runway.

According to a particular feature, the decision aid method also comprises an attribution step, implemented by an attribution module, consisting in respectively attributing a predetermined validity time:

to each of the current flight parameter or parameters, and

to each of the runway characteristic data concerning at least the first landing runway.

Furthermore, the attribution step consists in respectively attributing a predetermined validity time:

to each of the runway characteristic data concerning at least the second landing runway.

According to another particular feature, the decision aid method also comprises an updating step, implemented by an updating module, consisting in implementing at least one of the following substeps:

an acquisition substep, implemented by an acquisition submodule, consisting in acquiring at least one current flight parameter, as soon as the predetermined validity time attributed to said current flight parameter or parameters in the attribution step is exceeded by the time elapsed after the acquisition of said current flight parameter or parameters in the acquisition step or in a preceding acquisition substep;

a first reception substep, implemented by a first reception submodule, consisting in receiving at least one runway characteristic datum concerning at least the first landing runway or at least the second landing runway, as soon as the predetermined validity time attributed to said runway characteristic datum or data in the attribution step is exceeded by the time elapsed after the reception of said runway characteristic datum or data in the first reception step or in a preceding first reception substep.

According to a variant embodiment, the method also comprises a second reception step, implemented by a second reception module, consisting in receiving a second set of information comprising landing data concerning at least one landing of at least one preceding aircraft having landed previously on the first landing runway,

the first estimation step consisting in estimating at least one likelihood of at least one state in which the aircraft can be upon the landing, from the current flight parameters, the runway characteristic data and the landing data.

Advantageously, the uncertainty computation step also consists in respectively computing an uncertainty for each of the landing data concerning at least one landing of at least one preceding aircraft having landed previously on the first landing runway, each uncertainty being computed from an accuracy model associated with each of the landing data concerning at least one landing of at least one preceding aircraft having landed previously on the first landing runway.

More advantageously, the uncertainty computation step also consists in respectively computing an uncertainty for each of the landing data concerning at least one landing of at least one preceding aircraft having landed previously on the second landing runway, each uncertainty being computed from an accuracy model associated with each of the landing data concerning at least one landing of at least one preceding aircraft having landed previously on the second landing runway.

More advantageously, the attribution step also consists in respectively attributing a predetermined validity time to each of the landing data concerning at least one landing of at least one preceding aircraft having landed previously on the first landing runway.

More advantageously, the attribution step also consists in respectively attributing a predetermined validity time to each of the landing data concerning at least one landing of at least one preceding aircraft having landed previously on the second landing runway.

More advantageously, the updating step also consists in implementing a second reception substep, implemented by a second reception submodule, consisting in receiving at least one landing datum concerning at least one landing of at least one preceding aircraft having landed previously on the first landing runway, as soon as the predetermined validity time attributed to said landing datum or data in the attribution step is exceeded by the time elapsed after the reception of said landing datum or data in the second reception step or in a preceding second reception substep.

Moreover, the second set of information received in the second reception step also comprises landing data concerning at least one landing of at least one preceding aircraft having landed previously on at least the second landing runway.

Furthermore, the step of computation of assessment of at least one landing distance consists in computing a maximum landing distance from a function of probability density of the landing distance computed from the likelihood or likelihoods of the state or states and from the transition probability or probabilities.

Moreover, the determination step comprises:

a comparison substep, implemented by a comparison submodule, consisting in comparing the maximum landing distance with an available landing distance of the first landing runway and/or of at least the second landing runway, the available landing distance of the first landing runway and of at least the second landing runway being received in the first reception step in the first set of information,

a recommendation generation substep, implemented by a generation submodule, consisting in generating a recommendation signal representative of at least one recommendation based on the comparison of the comparison substep.

For example, the recommendation signal is representative of a positive recommendation to land on the first landing runway if the maximum landing distance is less than the available landing distance of the first landing runway, and the recommendation signal is representative of a negative recommendation to land on the first landing runway if the maximum distance is greater than or equal to the available landing distance of the first landing runway.

Furthermore, the recommendation signal is representative of a positive recommendation to land on the second landing runway or on another landing runway if the maximum landing distance is less than the available landing distance of the second landing runway or of the other landing runway, and the recommendation signal is representative of a negative recommendation to land on the second landing runway or on the other landing runway if the maximum distance is greater than or equal to the available landing distance of the second landing runway or of the other landing runway.

The invention relates also to a decision aid system prior to a start of final descent of an aircraft for a landing on a first landing runway.

According to an embodiment of the invention, the decision aid system comprises the following modules:

an acquiring module configured to acquire at least one current flight parameter of the aircraft;

a first reception module configured to receive a first set of information comprising runway characteristic data concerning at least the first landing runway on which the aircraft is likely to land;

a first estimation module configured to estimate at least one likelihood of at least one state in which the aircraft can be upon the landing, at least from the current flight parameters and the runway characteristic data;

a second estimation module configured to estimate at least one probability of transition between the state or states estimated by the first estimation module;

an assessment computation module configured to compute, in flight, an assessment of at least one landing distance likely to be travelled by the aircraft on at least the first landing runway from the likelihood or likelihoods of the state or states and from the transition probability or probabilities;

a determination module configured to determine at least one landing recommendation from the landing distance or distances;

a sending module configured to send a signal representative of the landing recommendation or recommendations to a user device.

The invention relates also to an aircraft, in particular a transport aeroplane, which comprises a decision aid system, such as that described above.

### BRIEF DESCRIPTION OF THE DRAWINGS

The invention, with its features and advantages, will emerge more clearly on reading the description given with reference to the attached drawings in which:

FIG. 1 schematically represents the decision aid system,

FIG. 2 schematically represents the decision aid method,

FIG. 3 represents an aircraft with the decision aid system on board,

FIG. 4 represents an aircraft likely to land on a first landing runway or a second landing runway.

### DETAILED DESCRIPTION

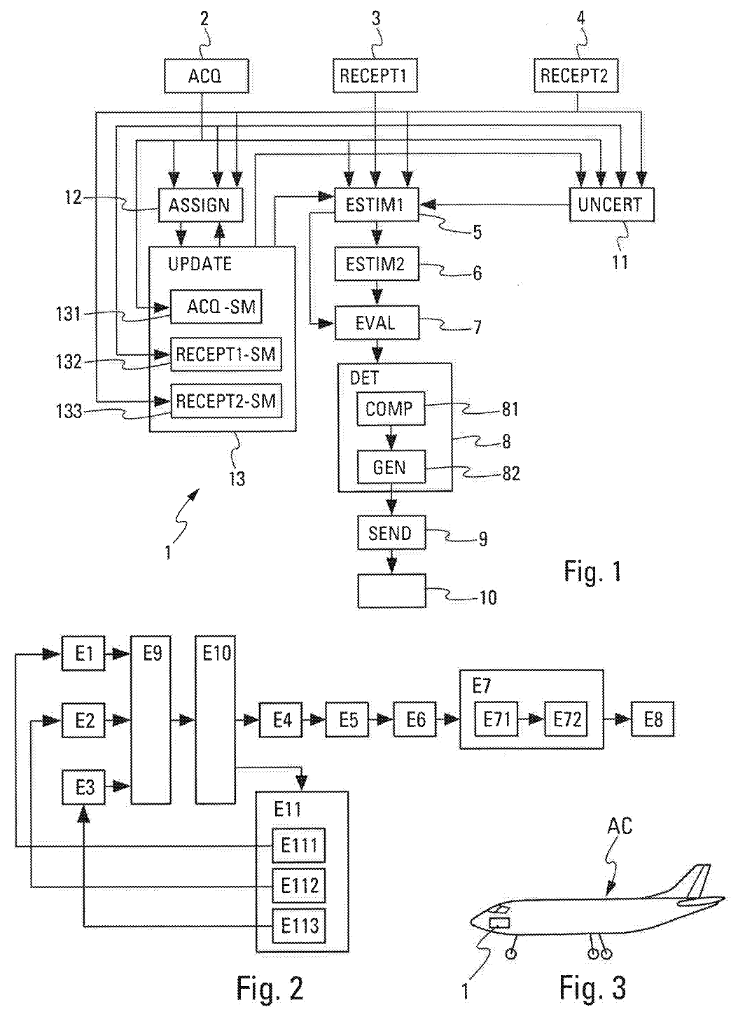

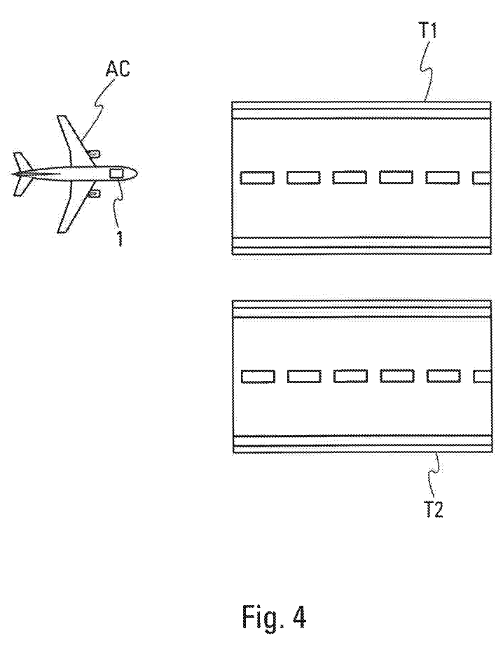

FIG. 1 schematically represents an embodiment of a decision aid system 1 prior to a start of final descent of an aircraft AC for a landing on a landing runway T1 (FIG. 4).

The decision aid system 1, embedded in the aircraft AC (FIG. 3), comprises an acquiring module ACQ 2 configured to acquire at least one current flight parameter of the aircraft AC.

The current flight parameter or parameters of the aircraft can be parameters directly available on the aircraft without these parameters being supplied by a device external to the aircraft and/or by communication devices. For example, the flight parameters can comprise at least some of the following current flight parameters: navigation parameters, parameters deriving from detection or measurement devices of the aircraft such as anticollision radars, inertial units (temperature, wind speed, wind direction, atmospheric pressure, etc.), configuration parameters entered by the pilot. The configuration parameters can be data concerning the selection by the pilot of the landing runway chosen for the landing, the position of the runway state selector, the mass of the aircraft AC, etc. Thus, the acquiring module 2 can comprise detection or measurement devices and devices configured to collect the configuration parameters of the aircraft AC.

The decision aid system 1 also comprises a reception module RECEPT1 3 configured to receive a first set of information comprising runway characteristic data concerning at least the landing runway T1 on which the aircraft AC is likely to land. The first set of information can comprise information on the traffic lanes.

According to a preferred embodiment, the first set of information also comprises at least runway characteristic data concerning one or more landing runways T2 (FIG. 4) on which the aircraft AC is likely to land if a landing recommendation determined by a recommendation determination module 8 recommends not landing on the first landing runway T1 (the determination module 8 is described hereinbelow in the description). The landing runway or runways T2 correspond to emergency landing runways if it appears that the aircraft AC risks a runway departure if it lands on the landing runway T1.

The first set of information, in the form of messages, can originate from ground systems transmitting messages in different formats. The formats can be structured or unstructured. In a nonlimiting manner, the ground systems comprise at least some of the following systems:
a NOTAM system transmitting notice messages to navigating personnel (NOTAM standing for “Notice to Airmen”) concerning the condition of runways of an aerodrome, or SNOWTAM, more particularly relating to the snow conditions of the runways of an aerodrome,
a METAR system transmitting aerodrome weather report messages (METAR standing for “Meteorological Aerodrome Report”),
an aerodrome forecast system TAF (TAF standing for “Terminal Aerodrome Forecast”) transmitting meteorological forecast messages for an aerodrome,
an ATIS system transmitting automatic terminal region information service messages (ATIS standing for “Automatic Terminal Information Service”),
a FICON system transmitting runway condition messages (FICON standing for “Field Condition”),
a PREP system transmitting pilot report messages (PREP standing for “Pilot Report”),
a system transmitting messages concerning weather conditions,
a “Computed Braking Action” system transmitting system report messages using the aircraft as sensor for computing the braking quality (“braking action”) qualifying the runway condition encountered on landing.

Other systems and other messages of the first set of information can be used by the decision aid system 1.

According to a preferred variant embodiment, the decision aid system 1 also comprises a reception module RECEPT2 4 configured to receive a second set of information comprising landing data concerning at least one landing of at least one preceding aircraft having landed previously on the first landing runway T1. The landing data can be the slipperiness of the landing runway, the turbulence generated by the preceding singular or multiple aircraft, the wind shear, the visibility on landing, the tailwind, etc. The first set of information in the form of messages being able to originate from ground systems or systems embedded in the preceding singular or multiple aircraft transmitting messages of different formats.

According to the preferred embodiment, the second set of information also comprises landing data concerning at least one landing of at least one preceding aircraft having landed previously on at least the second landing runway T2.

The decision aid system 1 also comprises an estimation module ESTIM1 5 configured to estimate at least one likelihood of at least one state in which the aircraft AC can be upon the landing, at least from the current flight parameters and the runway characteristic data. The estimation module 5 makes it possible to estimate the likelihood of estimated directly observable states of observable information. The estimation module 5 also makes it possible to estimate hidden states. A hidden state, unlike an observable state, is not directly observable but can be deduced by mathematical models from observable information.

According to the preferred variant embodiment, the estimation module 5 can estimate the likelihood or likelihoods of the state or states in which the aircraft AC can be upon the landing at least from the current flight parameters, the runway characteristic data and also the landing data received by the reception module 4.

The decision aid system 1 also comprises an estimation module 6 configured to estimate at least one probability of transition between the state or states estimated by the first estimation module 5. The estimated states correspond to the estimated observable states and/or to the estimated hidden states.

The decision aid system also comprises an assessment computation module 7 configured to compute, in flight, an assessment of at least one landing distance likely to be travelled by the aircraft AC on at least the first landing runway T1 from the likelihood or likelihoods of the state or states and from the transition probability or probabilities.

As an example, a landing distance D_{REF}_{ᵢ} travelled by the aircraft on a landing runway between a first speed V Touch Down and a second speed V_{end} of stopping on the runway or of runway exit to take a traffic lane can be expressed by the following expression:

$${D}_{REF} = {\int }_{{V}_{Touch Down}}^{{V}_{end}} \frac{m \cdot V}{T - D - {μ}_{REF} \cdot {F}_{{Z}_{MG}} - {μ}_{rolling} \cdot {F}_{{Z}_{NG}}} d V ,$$

in which:
the index MG (MG standing for “Main Gear”) represents the main landing gear of the aircraft AC,
the index NG (NG standing for “Nose Gear”) represents the front landing gear of the aircraft,
F_{Z} corresponds to the normal force generated by the mass of the aircraft AC,
m corresponds to the mass of the aircraft AC,
V corresponds to the ground speed of the aircraft AC,
T corresponds to the longitudinal thrust supplied by the engines of the aircraft AC during the travel on landing,
D corresponds to the drag of the aircraft AC during the travel on landing,
μ_{REF} corresponds to a reference friction level.

The landing distance D_{REF} travelled can be computed by taking account of the reference friction level of the reported state of the landing runway. The reference friction level can thus take, according to the Takeoff And Landing Performance Assessment TALPA procedure, six different reference friction levels. These reference friction levels comprise a level for which the landing runway is dry (DRY level) to a mediocre level (POOR level) through a good level (GOOD level), a good to passable level (GOOD TO MEDIUM level), a passable level (MEDIUM level) and a passable to mediocre level (MEDIUM TO POOR level). The reference friction levels are landing runway surface condition codes which can be sent to the aircraft AC by the system transmitting runway state messages FICON. From a probability of change of runway state to a lower reference level, it is possible to compute the landing distance D_{REF-1} associated with the lower friction level and the associated probability. The landing distance can be computed for each level associated with the probability of encountering this runway state.

The assessment computation module EVAL (EVAL standing for “Evaluation Module”) 7 can be configured to compute a maximum landing distance from a function of probability density of the landing distance computed from the likelihood or likelihoods of the state or states and from the probability or probabilities of transition between the states.

For example, the probability density function PDF corresponds to the following expression:

$$PDF ( Y ) = \frac{1}{{σ}_{Y} \sqrt{2 π}} \cdot {e}^{- \frac{1}{2} {( \frac{Y - {Y}_{0}}{{σ}_{Y}} )}^{2}} ,$$

in which:

$$- {σ}_{Y}^{2} = {\sum }_{j = 1}^{N} {( \frac{\partial Y}{\partial {X}_{j}} )}^{2} \cdot {σ}_{{X}_{j}}^{2} ,$$

Y₀ corresponds to the estimated landing distance or a reference estimated landing distance,
Xⱼ corresponds to the current flight parameter(s), to the information of the first set and/or to the information of the second set,
N corresponds to the total number of current flight parameters, of information of the first set and/or of information of the second set.

From the landing distance or distances, at least one landing recommendation is determined by a determination module 8 included in the decision aid system 1.

The recommendation can take account of the criteria defined before the flight by the pilot or the airline. These configuration criteria can for example define the additional margins on the landing distance with respect to the maximum distance, on the maximum wind with respect to the maximum wind recommended in the aircraft flight manual. These criteria can set the objectives for establishing the recommendation. Priority may be given to the objective of time of arrival rather than cost.

The decision aid system 1 comprises a sending module 9 configured to send a signal representative of the landing recommendation or recommendations to a user device 10.

The user device 10 can correspond to a display screen reading out the recommendations determined by the decision aid system 1.

For example, the screen can display a list of landing runways comprising the landing runway T1 and landing runways T2 in the vicinity of landing runway T1. For each landing runway, a recommendation is displayed in order to aid the pilot in deciding to land on the landing runway T1 or to land on another landing runway T2 if the landing runway T1 is not suitable for a safe landing.

Advantageously, the decision aid system 1 comprises an uncertainty computation module UNCERT (UNCERT standing for “Uncertainty Module”) 11 configured to respectively compute an uncertainty:

for each of the current flight parameter or parameters, and

for each of the runway characteristic data concerning at least the first landing runway T1.

Each uncertainty is computed from an accuracy model associated:

with each of the current flight parameter or parameters, and

with each of the runway characteristic data concerning at least the first landing runway T1.

According to the preferred embodiment, the uncertainty computation module 11 is configured to also compute, respectively, an uncertainty for each of the landing data concerning at least one landing of at least one preceding aircraft having landed previously on the first landing runway T1. Each uncertainty is computed from an accuracy model associated with each of the landing data concerning at least one landing of at least one preceding aircraft having landed previously on the first landing runway.

According to the preferred embodiment, the uncertainty module 11 is also configured to respectively compute an uncertainty for each of the runway characteristic data concerning at least the second landing runway T2.

Each uncertainty is computed from an accuracy model associated with each of the runway characteristic data concerning at least the second landing runway T2.

According to the preferred variant embodiment, the uncertainty module 11 is also configured to respectively compute an uncertainty for each of the landing data concerning at least one landing of at least one preceding aircraft having landed previously on the second landing runway T2. Each uncertainty is computed from an accuracy model associated with each of the landing data concerning at least one landing of at least one preceding aircraft having landed previously on the second landing runway T2.

The accuracy models can take account of bias in data entry by the pilot. For example, the mass of the aircraft AC entered may have been underestimated.

Similarly, the accuracy models can take account also of the influence of context parameters. For example, during the holiday season, the mass of the aircraft AC may have been underestimated by 600 kg instead of 500 kg during a period of normal activity.

The accuracy models can take account also of the influence of environmental parameters. For example, just after the application on the runway of ice-preventing chemical agent, the reference friction level of the runway may have been overestimated with a runway state at a GOOD level instead of a MEDIUM level.

The accuracy models can take account also of the influence of the airport equipment. For example, on a given airport, with runway friction measurement devices that are recognized as less accurate or less reliable, the runway reference friction level may have been overestimated.

Advantageously, the decision aid system 1 comprises an attribution model 12 configured to attribute respectively a predetermined validity (or obsolescence or expiration) time:

to each of the current flight parameters, and

to each of the runway characteristic data concerning at least the first landing runway T1.

According to the preferred variant embodiment, the attribution module 12 can also respectively attribute a predetermined validity time to each of the landing data concerning at least one landing of at least one preceding aircraft having landed previously on the first landing runway T1.

According to the preferred embodiment, the attribution module 12 is also configured to respectively attribute a predetermined validity time to each of the runway characteristic data concerning at least the second landing runway T2.

According to the preferred variant embodiment, the attribution module 12 can also respectively attribute a predetermined validity time to each of the landing data concerning at least one landing of at least one preceding aircraft having landed previously on the second landing runway T2.

For example, the information transmitted by:

the METAR system has a validity time of 30 min (or less during particular meteorological phenomena such as storms or gales),

the FICON system has a validity time of 10 min, 30 min or 1 h,

the PREP system has a substantially zero validity time (except in stable environmental conditions),

the system transmitting weather conditions messages has a validity time of 3 h.

The decision aid system 1 can comprise an updating module UPDATE 13 configured to implement at least one of the following submodules forming part of the updating module 13:

an acquisition submodule ACQ-SM (ACQ-SM standing for “acquisition submodule”) 131 configured to acquire at least one current flight parameter, as soon as the predetermined validity time attributed to said current flight parameter or parameters by the attribution module 12 is exceeded by the time elapsed after the acquisition of said current flight parameter or parameters by the acquiring module 2 or previously by the acquisition submodule 131. In the case where the current flight parameter is not available with the predetermined validity time, the uncertainty of the parameter can be degraded by the system via the accuracy model and the probability of change of state is increased;

a reception submodule RECPT1-SM 132 configured to receive at least one runway characteristic datum concerning at least the first landing runway T1 or at least the second landing runway T2 as soon as the predetermined validity time attributed to said runway characteristic datum or data by the attribution module 12 is exceeded by the time elapsed after the reception of said runway characteristic datum or data by the reception module 3 or previously by the reception submodule 132.

According to the preferred variant, the updating module 13 also comprises a reception submodule RECEPT2-SM 133 configured to receive at least one landing datum concerning at least one landing of at least one preceding aircraft having landed previously on the first landing runway T1 or on at least the second landing runway T2, as soon as the predetermined validity time attributed to said landing datum or data by the attribution module 12 is exceeded by the time elapsed after the reception of said landing datum or data by the reception module 4 or previously by the reception submodule 133.

The attribution module 12 can also attribute a validity time to the current flight parameter(s), to the runway characteristic datum or data, and, according to a variant embodiment, to the landing datum or data updated by the updating module 13. Similarly, the uncertainty computation module 11 can respectively compute an uncertainty on the current flight parameter or parameters, on the runway characteristic datum or data and on the landing datum or data updated by the updating module 13.

Advantageously, the determination module 8 comprises:

a comparison submodule 81 configured to compare at least the maximum landing distance with an available landing distance of the first landing runway T1 and/or of at least the second landing runway T2, the available landing distance of the first landing runway T1 and of at least the second landing runway (T2) being received by the reception module 3 in the first set of information. This comparison submodule 81 can also be configured to compare the maximum predicted crosswind with the maximum crosswind recommended in the flight manual of the aircraft,

a generation submodule 82 configured to generate a recommendation signal representative of at least one recommendation based on the comparison determined by the comparison submodule 81.

The generation submodule 82 can also generate a summary of the data collected and of the assessment computations culminating in the recommendation.

For example, the recommendation signal is representative of a positive recommendation to land on the first landing runway T1 if the maximum landing distance is less than the available landing distance of the first landing runway T1. The recommendation signal is representative of a negative recommendation to land on the first landing runway T1 if the maximum distance is greater than or equal to the available landing distance of the first runway.

According to the preferred embodiment, the recommendation signal is representative of a positive recommendation to land on the second landing runway T2 or on another landing runway if the maximum landing distance is less than the available landing distance of the second landing runway T2 or of the other landing runway. The recommendation signal is representative of a negative recommendation to land on the second landing runway T2 or on the other landing runway if the maximum distance is greater than or equal to the available landing distance of the second landing runway T2 or of the other landing runway.

The notion of landing distance likely to be travelled by the aircraft AC computed by the assessment computation module 7 can be widened to at least one of the following notions:

the distance to a complete stop associated with different landing techniques, braking modes;

the distance to the runway exit speed to the traffic lane associated with different landing techniques, braking modes;

the time of occupancy of the runway associated with different landing techniques, braking modes;

the time to arrive at the debarkation gate according to each traffic lane that can be envisaged and according to the different landing techniques, braking modes;

the energy accumulated in the brakes during braking and during taxiing;

the maximum temperature of the brakes reached after the flight;

the time of next possible departure taking into account the time of arrival at the debarkation gate and the brake cooling time;

the possible traffic lanes taking into account the computed landing distances;

the estimation of the wear of the brakes based on the energy accumulated in the brakes, the temperature of the brakes, the number of cycles;

the estimation of the corrosion of the brakes based on the energy accumulated in the brakes, the temperature of the brakes, the number of cycles on landing on runways treated by an ice-preventing chemical agent;

the fuel consumption to arrive at the debarkation gate via the computation of the fuel consumption for each phase (landing, wait on stopping and taxiing) based on the different landing techniques, braking modes, on the route on the traffic lanes to the debarkation gate and on the traffic on these lanes;

the estimation of the cost from the estimated fuel consumption, flight time, delay, maintenance;

the wind based on the runway characteristic data and on the landing data concerning at least one landing of at least one preceding aircraft having landed previously on the first landing runway;

the visibility based on the runway characteristic data and on the landing data concerning at least one landing of at least one preceding aircraft having landed previously on the first landing runway;

the outside temperature on the runway based on the runway characteristic data and on the landing data concerning at least one landing of at least one preceding aircraft having landed previously on the first landing runway.

For each notion computed by the assessment computation module 7, an uncertainty is computed based on an accuracy model associated:

with each of the current flight parameter or parameters,

with each of the runway characteristic data concerning at least the first landing runway T1 and

with each of the landing data concerning at least one landing of at least one preceding aircraft having landed previously on the first landing runway T1.

The decision aid system 1 can assist the pilot in deciding to at least:
choose a braking mode,
use the thrust reverser,
estimate that the landing distance is reasonable for a landing runway,
request additional information on a braking quality corresponding to a braking implemented by the pilot of a preceding aircraft,
request new information on the wind,
continue the landing or make a diversion,
know at which airport, on which runway and in what conditions he or she will be able to land if there is a diversion,
continue the landing or perform a go-around,
choose a landing technique,
choose a lateral control,
estimate whether the visibility is sufficient,
estimate whether the crosswind is tolerable,
request new information on the conditions of the landing runway of an airport,
remain in wait of landing runway maintenance (for snow clearance for example),
ask air traffic control ATC of the destination airport for a change of landing runway (to select a longer landing runway, for example),
choose the exit traffic lane and the exit speed.

The recommendations can also take account of means on the ground. For example, on an airport not equipped with lights at the center of the runway, it may be recommended to divert from a stronger visibility level than on a runway equipped with central lights.

The pilot can thus also check the controllability of the aircraft with respect to the wind and visibility conditions.

The decision aid system 1 can use an artificial intelligence capable of reproducing the decision-making of the pilot of the aircraft AC.

By virtue of this artificial intelligence, the decision aid system 1 can implement an automatic learning method in order to refine the landing distance computations by incorporating feedback from other aircraft of the same type.

The artificial intelligence can combine several assessments in order to determine several strategies making it possible at least to:
optimize the time to the debarkation gate,
select the traffic lane to be taken by using data representative of the traffic on the traffic lanes,
facilitate the routing over the traffic lanes,
optimize the time of occupancy of the landing runway,
optimize the fuel consumption,
use the braking to reduce the wear of the brakes and to reduce the immobilization time,
use the braking to reduce the corrosion on the runway treated by a chemical agent.

The invention relates also to a decision aid method prior to a start of final descent of an aircraft AC for a landing on a first landing runway T1 (FIG. 2).

The landing aid method comprises the following steps:

an acquisition step E1, implemented by the acquiring module 2, consisting in acquiring at least one current flight parameter of the aircraft AC;

a reception step E2, implemented by the reception module 3, consisting in receiving a first set of information comprising runway characteristic data concerning at least the landing runway T1 on which the aircraft AC is likely to land;

an estimation step E4, implemented by the estimation module 5, consisting in estimating at least a likelihood of at least one state in which the aircraft AC can be upon the landing, at least from the current flight parameters and the runway characteristic data;

an estimation step E5, implemented by the estimation module 6, consisting in estimating at least one probability of transition between the state or states estimated in the estimation step E4;

an assessment computation step E6, implemented by the assessment computation module 7, consisting in computing, in flight, an assessment of at least one landing distance likely to be travelled by the aircraft AC on at least the landing runway T1 from the likelihood or likelihoods of the state or states and on the transition probability or probabilities;

a determination step E7, implemented by the determination module 8, consisting in determining at least one landing recommendation from the landing distance or distances;

a sending step E8, implemented by the sending module 9, consisting in sending a signal representative of the landing recommendation or recommendations to a user device 10.

According to the preferred variant embodiment, the landing aid method also comprises a reception step E3, implemented by the reception module 4, consisting in receiving a second set of information comprising landing data concerning at least one landing of at least one preceding aircraft having landed previously on the landing runway T1. The estimation step E4 thus consists in estimating at least one likelihood of at least one state in which the aircraft AC can be upon the landing, at least from the current flight parameters, the runway characteristic data and the landing data.

The decision aid method can also comprise an uncertainty computation step E9, implemented by the uncertainty computation module 11, consisting in computing, respectively, an uncertainty:

for each of the current flight parameter or parameters, and

for each of the runway characteristic data concerning at least the first landing runway T1.

Each uncertainty is computed from an accuracy model associated:

with each of the current flight parameter or parameters, and

with each of the runway characteristic data concerning at least the first landing runway T1.

According to the preferred variant embodiment, the uncertainty computation step E9 consists also in respectively computing an uncertainty for each of the landing data concerning at least one landing of at least one preceding aircraft having landed previously on the first landing runway T1. Each uncertainty is computed on the basis of an accuracy model associated with each of the landing data concerning at least one landing of at least one preceding aircraft having landed previously on the first landing runway T1.

The uncertainty computation step E9 consists also in respectively computing an uncertainty for each of the runway characteristic data concerning at least the second landing runway T2. Each uncertainty is computed from an accuracy model associated with each of the runway characteristic data concerning at least the second landing runway T2.

According to the preferred variant embodiment, the uncertainty computation step E9 consists also in respectively computing an uncertainty for each of the landing data concerning at least one landing of at least one preceding aircraft having landed previously on the second landing runway T2. Each uncertainty is computed on the basis of an accuracy model associated with each of the landing data concerning at least one landing of at least one preceding aircraft having landed previously on the second landing runway T2.

The decision aid method can also comprise an attribution step E10, implemented by an attribution module 12, consisting in respectively attributing a predetermined validity time:

to each of the current flight parameter or parameters, and

to each of the runway characteristic data concerning at least the first landing runway T1.

According to the preferred variant embodiment, the attribution step E10 consists also in respectively attributing a predetermined validity time to each of the landing data concerning at least one landing of at least one preceding aircraft having landed previously on the first landing runway T1.

The attribution step E10 can also consist in respectively attributing a predetermined validity time to each of the runway characteristic data concerning at least the second landing runway T2.

According to the preferred variant embodiment, the attribution step can consist also in attributing a predetermined validity time to each of the landing data concerning at least one landing of at least one preceding aircraft having landed previously on the second landing runway T2.

The decision aid method can also comprise an updating step E11, implemented by the updating module 13, consisting in implementing at least one of the following substeps:

an acquisition substep E111, implemented by the acquisition submodule 131, consisting in acquiring at least one current flight parameter, as soon as the predetermined validity time attributed to said current flight parameter or parameters in the attribution step E10 is exceeded by the time elapsed after the acquisition of said current flight parameter or parameters in the acquisition step E1 or in a preceding acquisition substep E111;

a first reception substep E112, implemented by the reception submodule 132, consisting in receiving at least one runway characteristic datum concerning at least the first landing runway T1 or at least the second landing runway T2, as soon as the predetermined validity time attributed to said runway characteristic datum or data in the attribution step E10 is exceeded by the time elapsed after the reception of said runway characteristic datum or data in the first reception step E2 or in a preceding first reception substep E112.

According to the preferred variant embodiment, the updating step E11 consists also in implementing a second reception substep E113, implemented by the reception submodule 133, consisting in receiving at least one landing datum concerning at least one landing of at least one preceding aircraft having landed previously on the first landing runway T1 or on at least the second landing runway T2, as soon as the predetermined validity time attributed to said landing datum or data in the attribution step E10 is exceeded by the time elapsed after the reception of said landing datum or data in the second reception step E3 or in a preceding second reception substep E113.

The step E6 of computation of assessment of at least one landing distance can also consist in computing a maximum landing distance based on a function of probability density of the landing distance computed on the basis of the likelihood or likelihoods of the state or states and of the transition probability or probabilities.

Advantageously, the determination step E7 comprises:

a comparison substep E71, implemented by the comparison submodule 81, consisting in comparing the maximum landing distance with an available landing distance of the first landing runway T1 and/or of at least the second landing runway T2, the available landing distance of the first landing runway T1 and of at least the second landing runway T2 being received in the first reception step E2 in the first set of information,

a recommendation generation substep E72, implemented by the generation submodule 82, consisting in generating a recommendation signal representative of at least one recommendation based on the comparison of the comparison substep E71.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A decision aid method prior to a start of final descent of an aircraft for a landing on a first landing runway, the method comprising:
an acquisition step, implemented by an acquiring module, including acquiring at least one current flight parameter of the aircraft;
a first reception step, implemented by a first reception module, including receiving a first set of information comprising runway characteristic data concerning at least the first landing runway on which the aircraft is likely to land;
a first estimation step, implemented by a first estimation module, including estimating at least a likelihood of at least one state in which the aircraft can be upon the landing, at least from the current flight parameters and the runway characteristic data;
a second estimation step, implemented by a second estimation module, including estimating at least one probability of transition between the state or states estimated in the first estimation step;
an assessment computation step, implemented by an assessment computation module, including computing an in-flight assessment of at least one landing distance likely to be travelled by the aircraft on at least the first landing runway from the likelihood or likelihoods of the state or states and the transition probability or probabilities;
a determination step implemented by a determination module, including determining at least one landing recommendation from the landing distance or distances;
a sending step, implemented by a sending module, including sending a signal representative of the landing recommendation or recommendations to a user device.

2. The method according to claim 1, wherein the first set of information received in the first reception step further comprises at least runway characteristic data concerning at least one second landing runway on which the aircraft is likely to land if the landing recommendation determined in the determination step recommends not landing on the first landing runway.

3. The method according to claim 1, further comprising an uncertainty computation step, implemented by an uncertainty computation module, including computing, respectively, an uncertainty:
for each of the current flight parameter or parameters, and
for each of the runway characteristic data concerning at least the first landing runway,
each uncertainty being computed from an accuracy model associated:
with each of the current flight parameter or parameters, and
with each of the runway characteristic data concerning at least the first landing runway.

4. The method according to claim 3, wherein the uncertainty computation step further comprises respectively computing an uncertainty:
for each of the runway characteristic data concerning at least the second landing runway,
each uncertainty being computed from an accuracy model associated:
with each of the runway characteristic data concerning at least the second landing runway.

5. The method according to claim 1, further comprising an attribution step, implemented by an attribution module, including respectively attributing a predetermined validity time:
to each of the current flight parameter or parameters, and
to each of the runway characteristic data concerning at least the first landing runway.

6. The method according to claim 5, wherein the attribution step further comprises respectively attributing a predetermined validity time:
to each of the runway characteristic data concerning at least the second landing runway.

7. The method according to claim 1, further comprises an updating step, implemented by an updating module, including implementing at least one of the following substeps:
an acquisition substep, implemented by an acquisition submodule, including acquiring at least one current flight parameter, as soon as the predetermined validity time attributed to said current flight parameter or parameters in the attribution step is exceeded by the time elapsed after the acquisition of said current flight parameter or parameters in the acquisition step or in a preceding acquisition substep;
a first reception substep, implemented by a first reception submodule, including receiving at least one runway characteristic datum concerning at least the first landing runway or at least the second landing runway, as soon as the predetermined validity time attributed to said runway characteristic datum or data in the attribution step is exceeded by the time elapsed after the reception of said runway characteristic datum or data in the first reception step or in a preceding first reception substep.

8. The method according to claim 1, further comprising a second reception step, implemented by a second reception module, including receiving a second set of information comprising landing data concerning at least one landing of at least one preceding aircraft having landed previously on the first landing runway,
the first estimation step including estimating at least one likelihood of at least one state in which the aircraft can be upon the landing, from the current flight parameters, the runway characteristic data and the landing data.

9. The method according to claim 8, wherein the second set of information received in the second reception step also comprises landing data concerning at least one landing of at least one preceding aircraft having landed previously on at least the second landing runway.

10. The method according to claim 1, wherein the step of computation of assessment of at least one landing distance includes computing a maximum landing distance from a function of probability density of the landing distance computed from the likelihood or likelihoods of the state or states and from the transition probability or probabilities.

11. The method according to claim 1, wherein the determination step comprises:
a comparison substep, implemented by a comparison submodule, including comparing the maximum landing distance with an available landing distance of the first landing runway and/or of at least the second landing runway, the available landing distance of the first landing runway and of at least the second landing runway being received in the first reception step in the first set of information,
a recommendation generation substep, implemented by a generation submodule, including generating a recommendation signal representative of at least one recommendation based on the comparison of the comparison substep.

12. The method according to claim 11, wherein the recommendation signal is representative of a positive recommendation to land on the first landing runway if the maximum landing distance is less than the available landing distance of the first landing runway, and wherein the recommendation signal is representative of a negative recommendation to land on the first landing runway if the maximum distance is greater than or equal to the available landing distance of the first landing runway.

13. The method according to claim 11, wherein the recommendation signal is representative of a positive recommendation to land on the second landing runway or on another landing runway if the maximum landing distance is less than the available landing distance of the second landing runway or of the other landing runway, and wherein the recommendation signal is representative of a negative recommendation to land on the second landing runway or on the other landing runway if the maximum distance is greater than or equal to the available landing distance of the second landing runway or of the other landing runway.

14. A decision aid system prior to a start of final descent of an aircraft for a landing on a first landing runway, the system comprising:
an acquiring module configured to acquire at least one current flight parameter of the aircraft;
a first reception module configured to receive a first set of information comprising runway characteristic data concerning at least the first landing runway on which the aircraft is likely to land;
a first estimation module configured to estimate at least one likelihood of at least one state in which the aircraft can be upon the landing, at least from the current flight parameters and the runway characteristic data;
a second estimation module configured to estimate at least one probability of transition between the state or states estimated by the first estimation module;
an assessment computation module configured to compute, in flight, an assessment of at least one landing distance likely to be travelled by the aircraft on at least the first landing runway from the likelihood or likelihoods of the state or states and the transition probability or probabilities;
a determination module configured to determine at least one landing recommendation from the landing distance or distances;
a sending module configured to send a signal representative of the landing recommendation or recommendations to a user device.

15. An aircraft comprising a system according to claim 14.
